(19) United States
(12) Patent Application Publication
(10) Pub. No.: US 2025/0135637 A1
(43) Pub. Date: May 1, 2025

(54) GRIPPING DEVICE AND CONTROL METHOD BY GRIPPING DEVICE

(71) Applicant: MINEBEA MITSUMI Inc., Nagano (JP)

(72) Inventors: Toshiki KIMURA, Nagano (JP); Yusuke AOKI, Nagano (JP); Reiji YAMASAKI, Nagano (JP)

(21) Appl. No.: 18/684,011

(22) PCT Filed: Aug. 18, 2022
(86) PCT No.: PCT/JP2022/031208

§ 371 Date: Feb. 15, 2024

(30) Foreign Application Priority Data
Aug. 20, 2021 (JP) 2021-135160

(51) Int. Cl. B25J 9/16; B25J 15/08

(52) U.S. Cl. CPC B25J 9/1633; B25J 15/08

(57) ABSTRACT

A gripping device includes a motor, a detector configured to detect a position and a speed of a rotary shaft of the motor, a motor drive unit configured to supply power by which the motor is driven based on a current control value and to detect a magnitude of a current provided to the motor, a grasper configured to grip an object with a first finger and a second finger by changing a distance between the first finger and the second finger in accordance with rotation of the motor, a force detector configured to detect a grip force that enables the object to be gripped by the first finger and the second finger, and a controller configured to control the current control value such that a value of the detected grip force matches a force command value.

### TECHNICAL FIELD

The present disclosure relates to a gripping device and a control method by the gripping device.

### BACKGROUND

When product manufacturing lines are automated using a robot or the like, gripping devices called manipulators or grippers are used to grip objects to be gripped, such as mechanical components or electrical components.

Patent Document 1 discloses a control method for detecting an article gripping position of an article that is gripped by a hand of an assembling robot, comparing the article gripping position with an article-gripping reference position that is used as a preset reference, and controlling the driving of the assembling robot for the article, based on a deviation amount between these positions.

Patent Document 2 discloses a power controller in an assembling robot including a comparison unit that compares a detection result at a force information detector that is obtained in a work state and during preset normal operation for assembly, with current force information that is detected by the force information detector. As a result of the comparison by the force information detector, if the current force information does not match a target value that is obtained in a given stage, a correction unit that generates a correction signal to operate the assembling robot such that the current force information matches the target value is disclosed in Patent Document 2, where the correction unit outputs the correction signal to a robot controller.

Patent Document 3 discloses a robot device including a controller that detects an actual position at which an object is contacted based on outputs of force sensors at fingertips in a multifingered hand, and that corrects position information of an object based on information of the detected position at the object contacted.

### RELATED-ART DOCUMENTS

### Patent Documents

Patent Document 1: Japanese Unexamined Patent Application Publication No. H06-277959

Patent Document 2: Japanese Patent No. 3287151

Patent Document 3: Japanese Patent No. 5505138

### SUMMARY

### Problem to be Solved by the Invention

When a gripping device grips a particularly soft object to be gripped, it is required to grip the object without crushing the object.

The present disclosure provides a gripping device capable of gripping an object to be gripped without crushing the object.

### Means for Solving the Problem

In one aspect of the present disclosure, a gripping device includes a drive unit including a motor and a detector configured to detect a position and a speed of a rotary shaft of the motor, a motor drive unit configured to supply power by which the motor is driven based on a current control value and detect a current value for a current that is provided to the motor, a grasper including a first finger and a second finger, the grasper being configured to grip an object with the first finger and the second finger by changing a distance between the first finger and the second finger in accordance with rotation of the motor, a force detector configured to detect a grip force that enables the object to be gripped by the first finger and the second finger, upon occurrence of a condition in which the object is gripped by the first finger and the second finger, and a controller configured to output the current control value to the motor drive unit such that a grip-force detection value detected by the force detector matches a force command value. The controller includes a force controller, a position-command value generator, a contact determination unit, a switching unit, a position-and-speed calculator, and a current calculator. The force controller is configured to convert the force command value to a first position command value. The position-command value generator is configured to generate a second position command value. The contact determination unit is configured to detect that the first finger or the second finger contacts the object. Upon detecting by the contact determination unit that the first finger or the second finger contacts the object, the switching unit is configured to change the second position command value to the first position command value, and output the first position command value to the position-and-speed calculator. The position-and-speed calculator is configured to convert one of the first position command value and the second position command value that is input from the switching unit, to a current command value. The current calculator is configured to output the current control value such that the current value matches the current command value. The controller is configured to set the first position command value as a position detection value that is detected by the detector, in a case where the second position command value is changed to the first position command value.

### Effects of the Invention

According to a gripping device in the present disclosure, an object to be gripped can be gripped without crushing the object.

### BRIEF DESCRIPTION OF THE DRAWINGS

FIG. 1 is a diagram showing a configuration example of a gripping device according to a first embodiment.

FIG. 2 is a diagram for describing a functional configuration of the gripping device according to the first embodiment.

FIG. 3 is a diagram for describing a functional configuration of an arithmetic processing unit included in a controller of the gripping device according to the first embodiment.

FIG. 4 is a diagram for describing the functional configuration of an operational value calculator of the arithmetic processing unit included in the controller of the gripping device according to the first embodiment.

FIG. 5 is a diagram for describing a functional configuration of an admittance processing unit of the arithmetic processing unit included in the controller of the gripping device according to the first embodiment.

FIG. 6 is a diagram for describing a functional configuration of a position-and-speed calculator of the arithmetic processing unit included in the controller of the gripping device according to the first embodiment.

FIG. 7 is a diagram for describing a functional configuration of a current calculator of the arithmetic processing unit included in the controller of the gripping device according to the first embodiment.

FIG. 8 is a diagram for describing a functional arrangement of a position-command value generator of the arithmetic processing unit included in the controller of the gripping device according to the first embodiment.

FIG. 9 is a diagram for describing the operation of the gripping device according to the first embodiment.

FIG. 10 is a diagram for describing the operation of the gripping device in a comparative example.

FIG. 11 is a diagram for describing the operation of the gripping device according to the first embodiment and the gripping device in the comparative example.

FIG. 12 is a diagram for describing the operation of the gripping device according to the first embodiment and the gripping device in the comparative example.

FIG. 13 is a diagram for describing the functional configuration of the arithmetic processing unit included in the controller of the gripping device according to a second embodiment.

FIG. 14 is a flowchart for describing a process by a force command generator of the arithmetic processing unit included in the controller of the gripping device according to the second embodiment.

FIG. 15 is a diagram for describing the operation of the gripping device according to the second embodiment.

FIG. 16 is a flowchart for describing the process by the force command generator of the arithmetic processing unit included in the controller of the gripping device according to a third embodiment.

FIG. 17 is a diagram for describing the operation of the gripping device according to the third embodiment.

FIG. 18 is a flowchart for describing the process by the force command generator of the arithmetic processing unit included in the controller of the gripping device according to a fourth embodiment.

FIG. 19 is a diagram for describing the operation of the gripping device according to the fourth embodiment.

### MODE FOR CARRYING OUT THE INVENTION

### First Embodiment

### Gripping Device 1

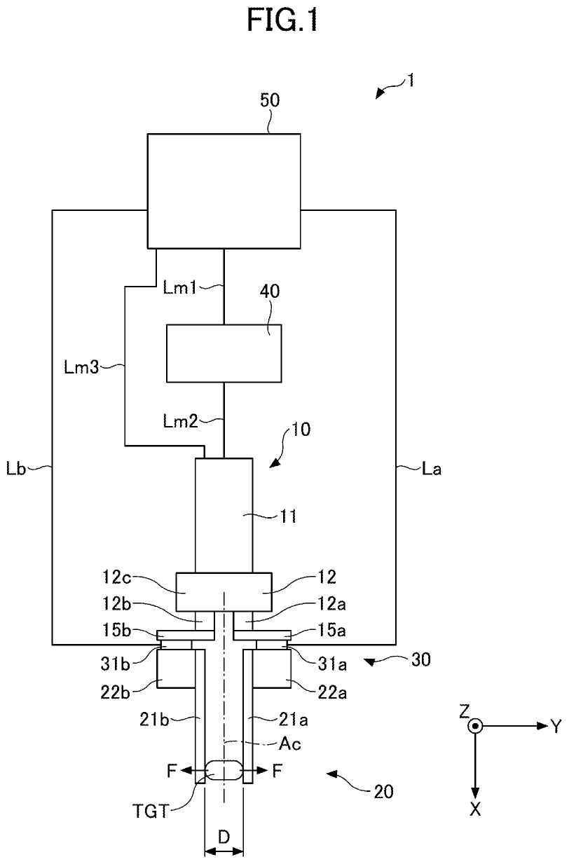

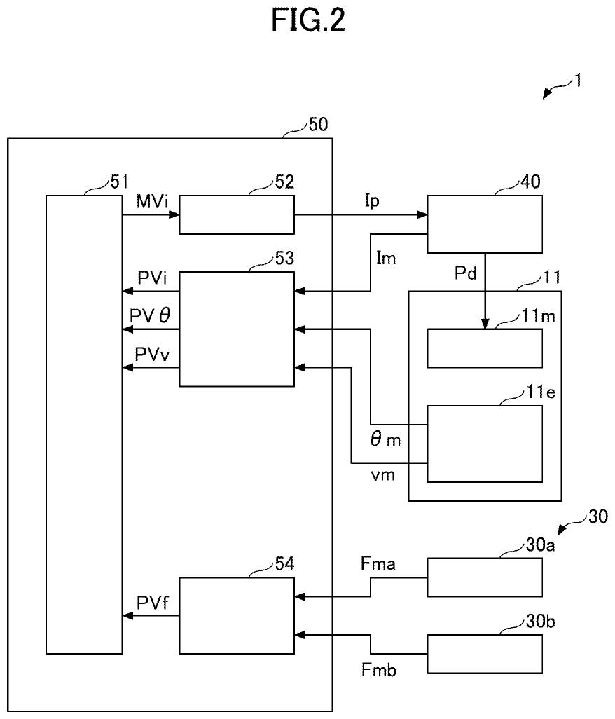

Hereinafter, a gripping device according to the present embodiment will be described in detail with reference to the drawings. FIG. 1 is a diagram showing a configuration example of a gripping device 1 according to the present embodiment. FIG. 2 is a diagram for describing a functional configuration of the gripping device 1 according to the present embodiment.

In FIG. 1, for ease of explanation, a virtual three-dimensional coordinate system (XYZ-orthogonal coordinate system), defined by an X-axis, a Y-axis, and a Z-axis (XYZ axes) that are mutually perpendicular, is set. However, the coordinate system is determined for the purpose of explanation, and a posture of the gripping device 1 is not intended to be limiting.

In FIG. 1, an X-axis direction refers to a direction in which a first finger 21a and a second finger 21b extend. In addition, a Y-axis direction refers to a direction in which each of the first finger 21a and the second finger 21b moves. The Z-axis corresponds to a direction perpendicular to the X-axis and the Y-axis.

The gripping device 1 is attached to, for example, an arm tip of a robot, and grips a grip target TGT. Specifically, the gripping device 1 grips the grip target TGT between the first finger 21a and the second finger 21b. The gripping device 1 includes a drive unit 10, a grasper 20, a force detector 30, a motor drive unit 40, and a controller 50. Each component of the gripping device 1 will be described in detail as follows.

The controller 50 and the motor drive unit 40 are coupled to each other by a wire Lm1. The motor drive unit 40 and the drive unit 10 are coupled by a wire Lm2, and more specifically the motor drive unit 40 and the drive unit 10 are the motor drive unit 40 and a power unit 11 (motor 11m) of the drive unit 10. Further, the controller 50 and the drive unit 10 are coupled by a wire Lm3, and more specifically the controller 50 and the drive unit 10 are the controller 50 and the power unit 11 (encoder 11e) of the drive unit 10.

### Drive Unit 10

The drive unit 10 changes a distance between the first finger 21a and the second finger 21b. Specifically, the drive unit 10 moves the first finger 21a and the second finger 21b in opposite directions of Y-axis directions.

The drive unit 10 includes the power unit 11 and a motion converter 12. The power unit 11 and the motion converter 12 will be described in detail as follows.

### Power Unit 11

The power unit 11 rotates a rotary shaft based on power that is supplied from the motor drive unit 40 via the wire Lm2. The power unit 11 converts the power to rotational motion, and transmits the rotational motion to the motion converter 12.

The power unit 11 includes the motor 11m and the encoder 11e. The motor 11m includes, for example, an alternating current (AC) motor or a stepping motor. The motor 11m rotates the rotary shaft based on the power (supplied power Pd) supplied from the motor drive unit 40. As described below, the supplied power Pd is determined based on a current control value MVi. In this arrangement, the motor 11m rotates based on the current control value MVi. Specifically, the motor 11m has any known configuration of the motor that includes the rotary shaft, a stator, a rotor, and the like.

The encoder 11e detects the position and the rotation speed of the rotary shaft of the motor 11m. The encoder 11e outputs a detection result to the controller 50 via the wire Lm3. The encoder 11e is an example of a detector.

### Motion Converter 12

The motion converter 12 converts the rotational motion that is transmitted from the motor 11m, to the linear motion in the Y-axis direction. The motion converter 12 is constituted, for example, by mechanism components such as a gear, a worm gear, and a cam. The motion converter 12 includes a moving unit 12a and a moving unit 12b each of which protrudes from a housing 12c. Each of the moving unit 12a and the moving unit 12b is movable with respect to the housing 12c. The motion converter 12 converts the rotational motion transmitted from the motor 11m to the linear motion that enables the moving unit 12a and the moving unit 12b to move in the Y-axis direction with respect to the housing 12c.

When the motor 11m rotates in one direction, for example, the moving unit 12a moves in a positive Y-direction of Y-axis directions. When the motor 11m rotates in an opposite direction, for example, the moving unit 12a moves in a negative Y-direction of the Y-axis directions. When the motor 11m rotates in one direction, for example, the moving unit 12b moves in the negative Y-direction of the Y-axis directions. When the motor 11m rotates in an opposite direction, for example, the moving unit 12b moves in the positive Y-direction of the Y-axis directions.

That is, when the motor 11m rotates in one direction, the moving unit 12a and the moving unit 12b move in opposite directions of the Y-axis direction, specifically in directions that are away from each other in the Y-axis directions. With this arrangement, when the motor 11m rotates in one direction, a greater distance between the moving unit 12a and the moving unit 12b is obtained. When the motor 11m rotates in the opposite direction, the moving unit 12a and the moving unit 12b move in opposite directions of the Y-axis directions, specifically in directions in which the moving unit 12a and the moving unit 12b are closer to each other in the Y-axis directions. Thus, when the motor 11m rotates in the opposite direction, a shorter distance between the moving unit 12a and the moving unit 12b is obtained.

As described above, the drive unit 10 can change the distance between the moving unit 12a and the moving unit 12b, in accordance with the rotation of the motor 11m.

### Grasper 20

The grasper 20 grips the grip target TGT between the first finger 21a and the second finger 21b, by using the drive unit 10.

The grasper 20 includes the first finger 21a and a first holder 22a for holding the first finger 21a, toward a positive Y-side of the Y-axis direction with respect to a central axis Ac. The first finger 21a is fixed to the first holder 22a. The first holder 22a is fixed to the moving unit 12a via a first force sensor 31a described below. The gripping device 1 includes a fixing unit 15a for fixing the first force sensor 31a to the moving unit 12a.

The grasper 20 includes a second finger 21b and a second holder 22b for holding the second finger 21b, toward a negative Y-side of the Y-axis direction with respect to the central axis Ac. The second finger 21b is fixed to the second holder 22b. The second holder 22b is fixed to the moving unit 12b via a second force sensor 31b described below. The gripping device 1 includes a fixing unit 15b for fixing the second force sensor 31b to the moving unit 12b.

When the moving unit 12a moves in the Y-axis direction, the first finger 21a moves in the Y-axis direction together with the moving unit 12a. Similarly, when the moving unit 12b moves in the Y-axis direction, the second finger 21b moves in the Y-axis direction together with the moving unit 12b. In this arrangement, when the distance between the moving unit 12a and the moving unit 12b varies, a distance D between the first finger 21a and the second finger 21b varies accordingly. By decreasing the distance D between the first finger 21a and the second finger 21b, the grasper 20 grips the grip target TGT, with the first finger 21a and the second finger 21b.

A case where the grip target TGT is gripped by the grasper 20 is limited to a case where the grip target TGT is gripped between the first finger 21a and the second finger 21b. For example, a given grip target having a ring shape may be gripped by moving fingers in a direction from the inside toward the outside of a ring in which the fingers are inserted.

### Force Detector 30

The force detector 30 detects a force (grip force) that is applied between the first finger 21a and the second finger 21b, when the grasper 20 grips the grip target TGT. The force detector 30 includes the first force sensor 31a and the second force sensor 31b. Each of the first force sensor 31a and the second force sensor 31b is, for example, a six-axis force sensor.

The first force sensor 31a is coupled to the controller 50 via the wire La. The second force sensor 31b is coupled to the controller 50 via the wire Lb. The force detector 30 uses a detection result on a force in the Y-axis direction that is output from the six axis force sensor.

The first force sensor 31a is fixed to the first holder 22a that holds the first finger 21a. The first force sensor 31a is fixed to the moving unit 12a via the fixing unit 15a. The first force sensor 31a detects a pushing force that the grip target TGT applies on the first finger 21a, when the grasper 20 grips the grip target TGT.

The second force sensor 31b is fixed to the second holder 22b that holds the second finger 21b. The second force sensor 31b is fixed to the moving unit 12b via a fixing unit 15b. The second force sensor 31b detects a pushing force that the grip target TGT applies on the second finger 21b, when the grasper 20 grips the grip target TGT.

The gripping device 1 according to the present embodiment includes the force detector 30 between the drive unit 10 and the grasper 20, but a location where the force detector 30 is provided is not limited to the location between the drive unit 10 and the grasper 20. For example, the gripping device 1 may include the first force sensor 31a and the second force sensor 31b at tips of the first finger 21a and the second finger 21b, respectively.

A type of the force sensor is not limited as long as the force sensor can detect the grip force that is applied between the first finger 21a and the second finger 21b. As the force sensor, for example, a micro electro mechanical systems (MEMS) sensor capable of detecting a force may be used, or a piezoelectric element or a strain gauge may be used. For example, when the MEMS sensor or the strain gauge is used, a flexure element that generates strain by an external force may be used to detect the force, or a portion of the grasper 20 may be used as the flexure element.

The force detector 30 according to the present embodiment includes the first force sensor 31a and the second force sensor 31b, but may include only one of the first force sensor 31a and the second force sensor 31b. That is, the force sensor may be provided in only one of the first finger 21a and the second finger 21b.

### Motor Drive Unit 40

The motor drive unit 40 supplies power (supplied power Pd) to the drive unit 10, more specifically to the motor 11m, based on an operation command (current control signal Ip) from the controller 50. The drive unit 10 is driven by the power supplied from the motor drive unit 40. The drive unit 10 is driven by the power supplied from the motor drive unit 40, and thus the drive unit 10 operates based on the operation command from the controller 50.

The motor drive unit 40 outputs a current value (drive current value Im) that is derived from the power supplied to the drive unit 10, to the controller 50. The controller 50 controls the drive unit 10, using the current value for the current that the motor drive unit 40 provides to the drive unit 10.

### Controller 50

The controller 50 controls the drive unit 10 such that the grip force (each of a first grip force value Fma and a second grip force value Fmb), detected by the force detector 30, becomes a desired grip force. The controller 50 also performs a control using the position (position information θm) and the rotation speed (speed information vm) of the rotary shaft that are detected by the encoder 11e, and using a current signal (drive current value Im) from the motor drive unit 40.

The controller 50 is implemented by a micro-processing unit that includes a central processing unit (CPU), a random access memory (RAM), and a read only memory (ROM), for example. The controller 50 performs processing when the CPU loads a program recorded in the ROM into the RAM and then executes the program.

The controller 50 includes an arithmetic processing unit 51, a motor controller 52, a motor-operation data acquiring unit 53, and a force-measurement data acquiring unit 54. The arithmetic processing unit 51 outputs a current control value MVi to the motor controller 52. The motor-operation data acquiring unit 53 outputs, to the arithmetic processing unit 51, a current detection value PVi that is a current value of the drive current that is supplied by the motor drive unit 40 to the power unit 11 (motor 11m), a position detection value PVθ associated with the rotary shaft of the motor 11m, and a speed detection value PVv associated with the rotary shaft. The force-measurement data acquiring unit 54 outputs, to the arithmetic processing unit 51, a grip-force detection value PVf associated with the grip force F, which is received from the grip target TGT and is detected by the force detector 30. The details of each component will be described below.

### Arithmetic Processing Unit 51

The arithmetic processing unit 51 calculates the operational value for operating the drive unit 10 such that a control value becomes a target value. Specifically, the arithmetic processing unit 51 calculates the current control value MVi such that the grip-force detection value PVf as the control value becomes a grip force value used as the target value. The details of the arithmetic processing unit 51 are described below. In the arithmetic processing unit 51 according to the present embodiment, the current control value MVi is output as the operational value, but the operational value of power, a voltage, or the like may be used based on an object to be controlled, instead of using the current.

### Motor Controller 52

The motor controller 52 outputs the operational value for operating the power unit 11, specifically the motor 11m, to the motor drive unit 40. In detail, the motor controller 52 performs a conversion to a current control signal Ip that can be input to the motor drive unit 40, based on the current control value MVi output from the arithmetic processing unit 51. Then, the motor controller 52 outputs the current control signal Ip that is obtained in the conversion, to the motor drive unit 40.

The motor controller 52 may output an analog signal as the current control signal Ip, such as a voltage signal or a current signal, as long as the current control signal Ip can be input to the motor drive unit 40. Alternatively, the motor controller 52 may output a digital signal as the current control signal Ip. The motor drive unit 40 provides supplied power Pd to the motor 11m of the power unit 11 based on the current control signal Ip.

### Motor-Operation Data Acquiring Unit 53

The motor-operation data acquiring unit 53 acquires motor operation data related to an operational state of the power unit 11, from the power unit 11 and the motor drive unit 40. Specifically, the motor-operation data acquiring unit 53 acquires, from the motor drive unit 40, the drive current value Im that is derived from the supplied power Pd that is provided to the power unit 11 by the motor drive unit 40. The motor-operation data acquiring unit 53 acquires position information θm and speed information vm of the rotary shaft of the motor 11m, from the encoder 11e.

The motor-operation data acquiring unit 53 may acquire the drive current value Im from the motor drive unit 40, for example, by using an analog signal or a digital signal. Similarly, the motor-operation data acquiring unit 53 may acquire, from the encoder 11e, each of the position information θm and the speed information vm, for example, by using the analog signal or the digital signal.

The motor-operation data acquiring unit 53 outputs the current detection value PVi to the arithmetic processing unit 51 based on the acquired drive current value Im. The motor-operation data acquiring unit 53 outputs a position detection value PVθ to the arithmetic processing unit 51, based on the acquired position information θm. Further, the motor-operation data acquiring unit 53 outputs a speed detection value PVv to the arithmetic processing unit 51, based on the acquired speed information vm.

### Force-Measurement Data Acquiring Unit 54

The force-measurement data acquiring unit 54 acquires measurement data of the grip force F from the force detector 30. Specifically, the force-measurement data acquiring unit 54 acquires a first grip force value Fma from the first force sensor 31a. The force-measurement data acquiring unit 54 acquires a second grip force value Fmb from the second force sensor 31b.

The force-measurement data acquiring unit 54 may acquire the first grip force value Fma from the first force sensor 31a, for example, by using the analog signal or the digital signal. Similarly, the force-measurement data acquiring unit 54 may acquire the second grip force value Emb from the second force sensor 31b, for example, by using the analog signal or the digital signal.

The force-measurement data acquiring unit 54 outputs the grip-force detection value PVf to the arithmetic processing unit 51, based on the acquired first grip force value Fma and second grip force value Fmb. For example, the force-measurement data acquiring unit 54 may output an average grip force value of the first grip force value Fma and the second grip force value Emb as the grip-force detection value PVf.

### Details of Processing of Arithmetic Processing Unit 51

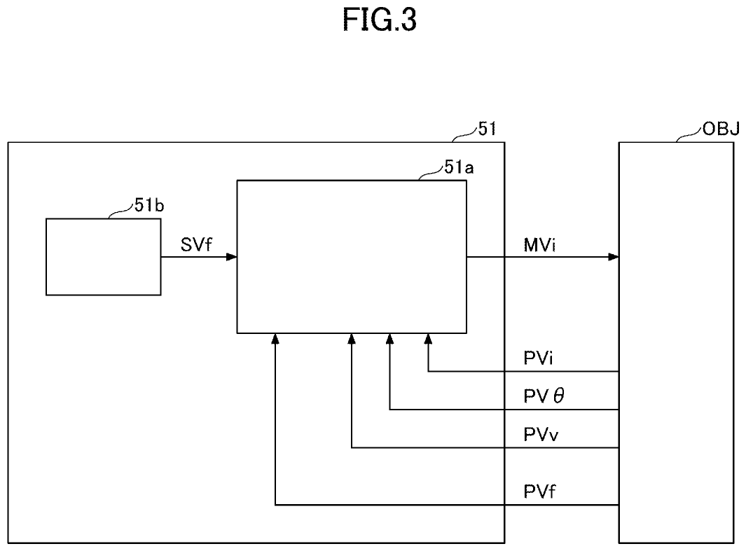

The process by the arithmetic processing unit 51, in other words, steps in a control method executed by the gripping device 1 will be described below in detail. FIG. 3 is a diagram illustrating a functional configuration of the arithmetic processing unit 51 included in the controller 50 of the gripping device 1 according to the first embodiment. In FIG. 3, components provided outside the arithmetic processing unit 51 are collectively shown as objects OBJ to be controlled by the arithmetic processing unit 51. The objects OBJ include, for example, the drive unit 10, the force detector 30, the motor drive unit 40, the motor controller 52, the motor-operation data acquiring unit 53, and the force-measurement data acquiring unit 54.

In the gripping device 1 according to the first embodiment, a control is implemented by position and speed control before the gripping device 1 comes into contact with the grip target TGT in order to operate at high speed before the grip target TGT is contacted. After the grip target TGT is contacted, the control is implemented by force control.

The arithmetic processing unit 51 determines a force command value SVf of the grip force F. The arithmetic processing unit 51 calculates the current control value MVi such that the grip-force detection value PVf matches the force command value SVf. The arithmetic processing unit 51 uses the current detection value PVi, the position detection value PVθ, and the speed detection value PVV to calculate the current control value MVi.

The arithmetic processing unit 51 includes an operational value calculator 51a and a force command generator 51b.

### Operational Value Calculator 51a

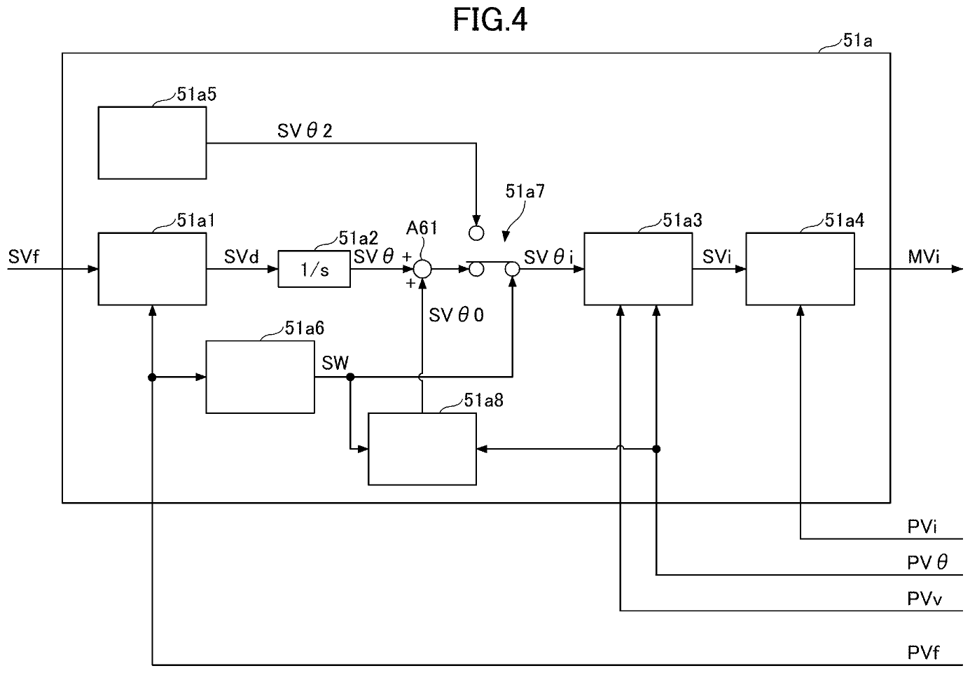

The operational value calculator 51a calculates the current control value MVi such that the grip-force detection value PVf matches the force command value SVf that the force command generator 51b sets. FIG. 4 is a diagram illustrating a functional configuration of the operational value calculator 51a of the arithmetic processing unit 51 included in the controller 50 of the gripping device 1 according to the first embodiment. In a block diagram, “1/s” expresses the integral.

The operational value calculator 51a includes an admittance processing unit 51a1, an integration operator 51a2, a position-and-speed calculator 51a3, a current calculator 51a4, a position-command value generator 51a5, a contact determination unit 51a6, a switching unit 51a7, and a value holder 51a8. The operational value calculator 51a further includes an addition-and-subtraction block A61. Each of arithmetic component will be described as follows.

### Admittance Processing Unit 51a1

The admittance processing unit 51a1 converts the force command value SVf to a displacement command value SVd. The admittance processing unit 51a1 calculates (generates) the displacement command value SVd such that the grip-force detection value PVf matches the force command value SVf. FIG. 5 is a diagram for describing a functional configuration of the admittance processing unit 51a1 of the arithmetic processing unit 51 included in the controller 50 of the gripping device 1 according to the first embodiment.

The admittance processing unit 51a1 controls parameters in virtual mass-spring-damper systems by solving a differential equation shown in Equation 1. Here, ΔF is difference between the force command value SVf and the grip-force detection value PVf, M (gain K11) is the weight, C (gain K12) is a damping coefficient for the damper, K (gain K13) is a spring constant for the spring, and x is displacement.

$$\begin{matrix}[ Equation 1 ] & \\ Δ F = M \frac{{d}^{2} x}{{dt}^{2}} + C \frac{d x}{d t} + Kx & ( EQUATION 1 )\end{matrix}$$

The admittance processing unit 51a1 calculates the difference between the force command value SVf and the grip-force detection value PVf, by an addition-and-subtraction block A11. Then, a result of the calculation by an integration block B11 (gain K11) is processed by a gain block B13 (gain K12), and then the resulting value is fed back to an addition-and-subtraction block A13. The result of the process by the integration block B11 is processed by an integration block B12, and a processed result is processed by a gain block B14 (gain K13) and the resulting value is fed back to the addition-and-subtraction block A12. Then, a processed result is output as the displacement command value SVd. In addition to the above admittance control by the admittance processing unit 51a1, for example, a force control in which the displacement command value SVd is determined based on the grip-force detection value PVf, using only the spring constant K may be performed.

The admittance processing unit 51a1 is an example of a force control calculator that converts the force command value SVf to the displacement command value SVd. A method of converting the command value SVf to the displacement command value SVd is not limited to a method executed by the admittance processing unit 51a1, and various approaches can be adopted.

### Integration Operator 51a2

The integration operator 51a2 integrates the displacement command value SVd that is output from the admittance processing unit 51a1, and changes the displacement command value to a position command value SVθ. With use of the admittance processing unit 51a1 and the integration operator 51a2, positions of the first finger 21a and the second finger 21b are adjusted such that the grip-force detection value PVf matches the force command value SVf.

### Position-and-Speed Calculator 51a3

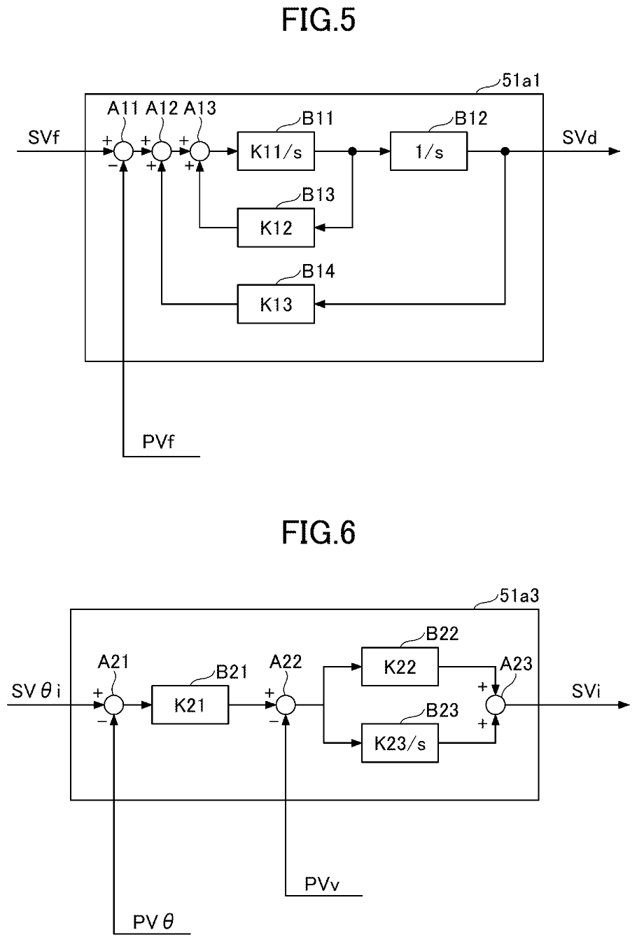

The position-and-speed calculator 51a3 calculates a current command value SVi such that the first finger 21a and the second finger 21b are disposed at positions that are identified by a position command value SVθi that is output from the addition-and-subtraction block A1, and then the position-and-speed calculator 51a3 outputs the current command value SVi. The position-and-speed calculator 51a3 calculates (generates) the current command value SVi such that the position detection value PVθ matches the position command value SVθi. Specifically, the position-and-speed calculator 51a3 performs P (proportional) control for the position, and performs PI (proportional-integral) control for the speed. FIG. 6 is a diagram illustrating a functional configuration of the position-and-speed calculator 51a3 of the arithmetic processing unit 51 included in the controller 50 of the gripping device 1 according to the first embodiment.

The position-and-speed calculator 51a3 determines a difference between the position command value SVθi and the position detection value PVθ, by using an addition-and-subtraction block A21. Then, the position-and-speed calculator 51a3 performs a calculation by a gain block B21 (gain K21), and determines a difference from the speed detection value PVv, by using an addition-and-subtraction block A22. Then, the position-and-speed calculator 51a3 processes the determined difference by a gain block B22 (gain K22) and an integration block B23 (gain K23), and adds a processed result by an addition-and-subtraction block A23. Then, the position-and-speed calculator 51a3 outputs the current command value SVi. Gains including the gain K21 and the like are appropriately determined in consideration of a system response and the like.

### Current Calculator 51a4

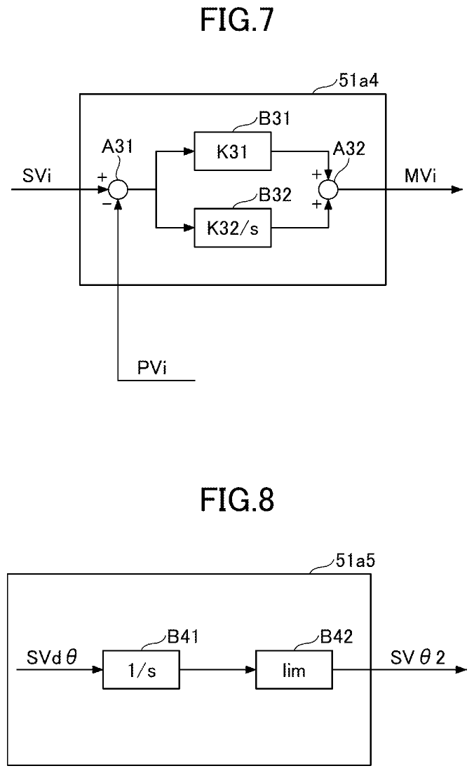

The current calculator 51a4 converts the current command value SVi output from the position-and-speed calculator 51a3 to a current control value MVi. The current calculator 51a4 calculates (generates) the current control value MVi such that the current detection value PVi matches the current command value SVi. Specifically, the current calculator 51a4 performs PI control for the current. FIG. 7 is a diagram illustrating a functional configuration of the current calculator 51a4 of the arithmetic processing unit 51 included in the controller 50 of the gripping device 1 according to the first embodiment.

The current calculator 51a4 determines a difference between the current command value SVi and the current detection value PVi, by using the addition-and-subtraction block A31. Then, the current calculator 51a4 processes the determined difference by the gain block B31 (gain K31) and the integration block B32 (gain K32), and adds a processed result by the addition-and-subtraction block A32. Then, the current calculator 51a4 outputs the current control value MVi.

### Position-Command Value Generator 51a5

The position-command value generator 51a5 generates a position command value SVθ2 used in position control. The position-command value generator 51a5 calculates (generates) the position command value SVθ2 that changes at a constant change rate before the position command value SVθ2 becomes a constant value. FIG. 8 is a diagram for describing a functional configuration of the position-command value generator 51a5 of the operational value calculator 51a included in the controller of the gripping device according to a second embodiment.

The position-command value generator 51a5 calculates the position command value SVθ2 based on a position-displacement command value SVdθ. The position-displacement command value SVdθ corresponds to a differential of the position command value SVθ2. The position command value SVθ2 increases in proportion to time. The position command value SVθ2 indicates a distance between the first finger 21a and the second finger 21b. In accordance with an increasing position command value SVθ2, the distance between the first finger 21a and the second finger 21b is reduced. In this arrangement, the resulting value varies until the first finger 21a and the second finger 21b contact each other. That is, the value changes until there is no distance between the first finger 21a and the second finger 21b.

The position-command value generator 51a5 integrates the position-displacement command value SVdθ by using an integration block B41. Further, by a limiting block B42, the resulting value is set to a predetermined value or less. Specifically, the resulting value is set to a value or less that enables the first finger 21a and the second finger 21b to contact with each other. Then, the position-command value generator 51a5 outputs the position command value SVθ2.

A method of generating the position command value SVθ2 by the position-command value generator 51a5 described above is an example of a method of generating the position command value SVθ2. The position command value SVθ2 may be generated with any other approach.

### Contact Determination Unit 51a6

The contact determination unit 51a6 determines whether the grip target TGT contacts the first finger 21a and the second finger 21b, based on the grip-force detection value PVf. Then, a determination result is output to both the switching unit 51a7 and the value holder 51a8, as a switch signal SW.

### Switching Unit 51a7

With use of the switch signal SW, the switching unit 51a7 outputs one of the position command value sve and the position command value SVθ2 to the position-and-speed calculator 51a3 as the position command value SVθi. One input of the switching unit 51a7 is coupled to the integration operator 51a2, and the other input of the switching unit 51a7 is coupled to the position-command value generator 51a5. An output of a switching unit 252a7 is coupled to the position-and-speed calculator 51a3.

In the gripping device 1 according to the first embodiment, by the contact determination unit 51a6 and the switching unit 51a7, the control is changed before and after the first finger 21a and the second finger 21b contact the grip target TGT. Specifically, until the first finger 21a and the second finger 21b contact the grip target TGT, the position command value SVθ2 output from the position-command value generator 51a5 is input to the position-and-speed calculator 51a3 as the position command value SVθi, by using the switching unit 51a7. With this arrangement, until the first finger 21a and the second finger 21b contact the grip target TGT, the gripping device 1 according to the first embodiment controls the drive unit 10 by position and speed control.

In the gripping device 1 according to the first embodiment, the first finger 21a and the second finger 21b can move at high speed by controlling the drive unit 10 by position and speed control, until the first finger 21a and the second finger 21b contact the grip target TGT.

After the first finger 21a and the second finger 21b contact the grip target TGT, the position command value SVθ output from the integration operator 51a2 is input to the position-and-speed calculator 51a3 as the position command value SVθi, by using the switching unit 51a7. With this arrangement, as of the first finger 21a and the second finger 21b contacting the grip target TGT, the gripping device 1 according to the first embodiment controls the drive unit 10 by force control.

In the gripping device 1 according to the first embodiment, after the first finger 21a and the second finger 21b contact the grip target TGT, the drive unit 10 is controlled by the force control. In this arrangement, the first finger 21a and the second finger 21b move slowly so that the grip target TGT can be softly gripped.

### Value Holder 51a8

Based on the switch signal SW, the value holder 51a8 outputs the position detection value PVθ as a position command value SVθ0, when the grip target TGT contacts the first finger 21a and the second finger 21b.

### Addition-and-Subtraction Block A61

The addition-and-subtraction block A61 adds the position command value SVθ output from the integration operator 51a2 and the position command value SVθ0 output from the value holder 51a8. Then, the addition-and-subtraction block A61 outputs the position command value SVθi to the position-and-speed calculator 51a3.

### Force Command Generator 51b

The force command generator 51b outputs the power command value SVf that is a constant value.

### Operation of Gripping Device 1 According to First Embodiment

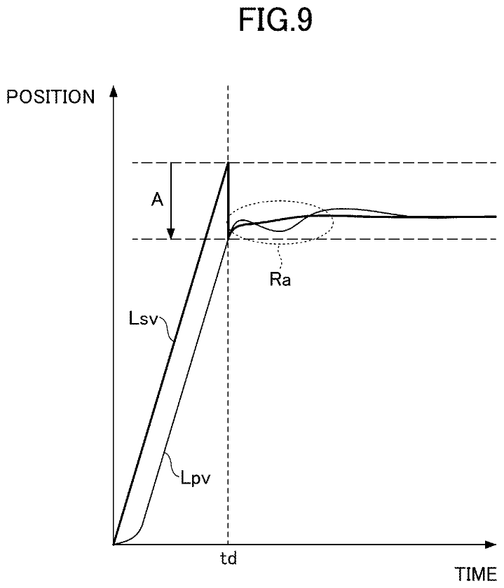

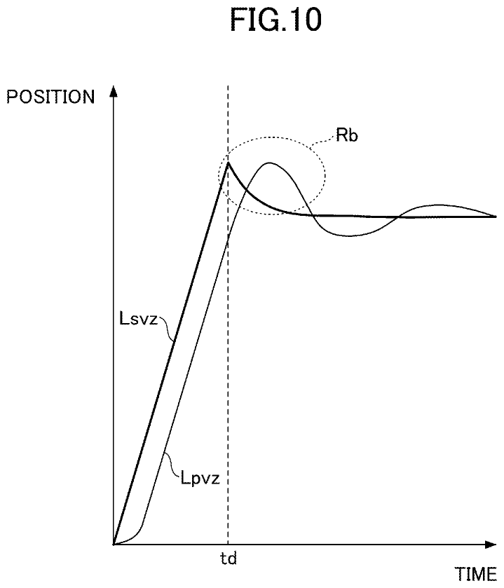

The operation of the gripping device 1 according to the first embodiment will be described as follows. FIG. 9 is a diagram for describing the operation of the gripping device 1 according to the first embodiment. The vertical axis in FIG. 9 expresses position values relating to the position command value SVθ, the position detection value PVθ, and the like. The vertical axis in each of FIGS. 10, 11, and 12 expresses the position values as in FIG. 9. The horizontal axis in FIG. 9 expresses time from the starting of the operation. The horizontal axis in each of FIGS. 10, 11, and 12 expresses the time as in FIG. 9.

In FIG. 9, a line Lsv indicates the position command value SVθi that is input to the position-and-speed calculator 51a3, and a line Lpv indicates the position detection value PVθ. Time td indicates time at which the first finger 21a and the second finger 21b are in contact with the grip target TGT.

At the time td at which the first finger 21a and the second finger 21b are in contact with the grip target TGT, the operational value calculator 51a changes the position command value SVθ to be the same as the position detection value PVθ at the time td. That is, as indicated by an arrow A in FIG. 9, the position command value SVθ is changed to the position detection value PVθ at the time td. At the time td, the operational value calculator 51a changes the position command value SV to correspond to the position detection value PVθ at the time td. That is, in FIG. 9, the position command value SVθ is changed to be the same as the position detection value PVθ at the time td. By use of the operational value calculator 51a at the time td at which the position command value SVθ is changed to be the same as the position detection value PVθ at the time td, variations in the position detection value PVθ can be reduced as indicated by Ra. Further, the convergence of the position detection value PVθ can be facilitated.

On the other hand, a case where there is no change in the position command value SVθ will be described below using a gripping device in a comparative example in FIG. 10. In the gripping device in the comparative example, the position command value SVθ does not change. In FIG. 10, a line Lsvz indicates the position command value SVθi that is input to the position-and-speed calculator 51a3 of the gripping device in the comparative example, and a line Lpvz indicates the position detection value PVθ that is used in the gripping device in the comparative example.

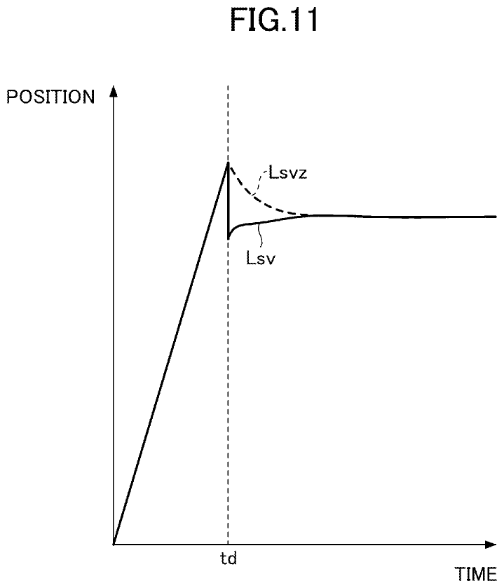

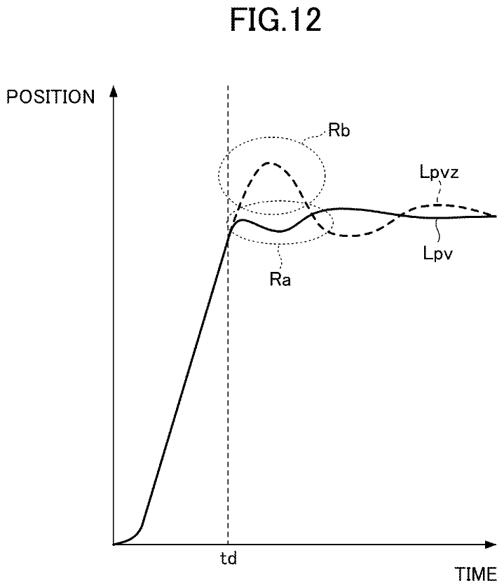

FIG. 11 is a graph showing position command values SVθ for the gripping device 1 according to the first embodiment and the gripping device in the comparative example. Further, FIG. 12 is a graph illustrating position detection values PVθ for the gripping device 1 according to the first embodiment and the gripping device in the comparative example.

In the gripping device in the comparative example, from the fact that the position command value SVθ is increased at the time td, hunting occurs significantly with respect to the position detection value PVθ, as indicated by Rb. In addition, the convergence of the position detection value PVθ is also delayed.

In the gripping device 1 according to the first embodiment, hunting occurring when the control is changed can be suppressed, compared to the gripping device in the comparative example. By suppressing the hunting, the gripping device 1 according to the first embodiment can grip the grip target TGT without greatly crushing the grip target TGT, after gripping the grip target TGT. Further, in the gripping device 1 according to the first embodiment, after changing the control, the convergence can be made early, compared to the gripping device of the comparative example.

### Action and Effect

In the control of the gripping device 1 according to the first embodiment, rapid position and speed control and fine force control can be performed. In the gripping device 1 according to the first embodiment, when the first finger 21a and the second finger 21b contact the grip target TGT, the position command value SVθi is set to be the same as the position detection value PVθ that is obtained at a timing at which the first finger 21a and the second finger 21b contact the grip target TGT. With this arrangement, the grip target TGT can be prevented from being crushed when the grip target TGT is gripped.

Further, in the gripping device 1 of the first embodiment, by performing the control using the grip-force detection value PVf detected by the force detector 30, the grip target TGT can be stably gripped by a constant grip force. Further, in the gripping device 1 of the first embodiment, by the control using the grip-force detection value PVf detected by the force detector 30, gripping can be stably performed by a weak grip force.

Furthermore, in the gripping device 1 of the first embodiment, even if gripping positions of the first finger 21a and the second finger 21b change greatly, such that the first finger 21a and the second finger 21b are greatly influenced by cogging torque that depends on positions of a magnet and an iron core of the motor, the effect of the cogging torque of the motor, which is a disturbance that depends on the positions, can be compensated under the control by the admittance processing unit 51a1.

The position command value SVθ is an example of a first position command value, and the position command value SVθ2 is an example of a second position command value.

### Second Embodiment

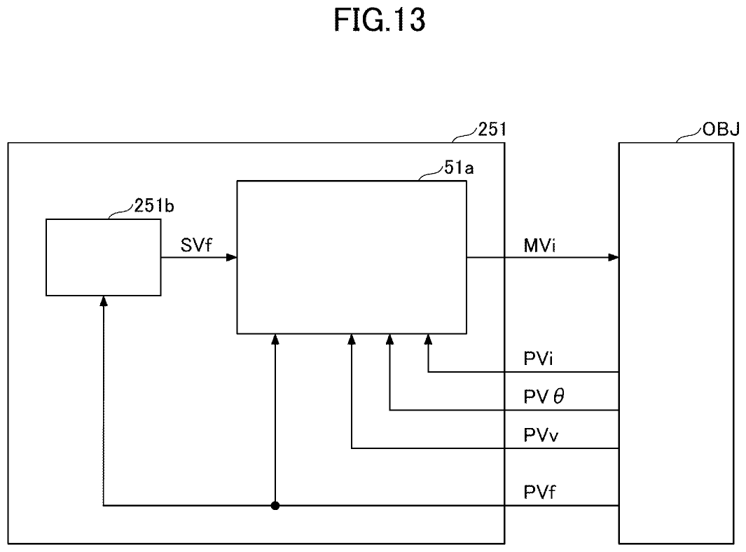

The gripping device according to a second embodiment includes an arithmetic processing unit 251 instead of the arithmetic processing unit 51 of the gripping device 1 according to the first embodiment. The gripping device according to the second embodiment includes a force command generator 251b instead of the force command generator 51b of the gripping device 1 according to the first embodiment. FIG. 13 is a diagram for describing the functional configuration of the arithmetic processing unit 251 included in the controller of the gripping device according to the second embodiment.

### Force Command Generator 251b

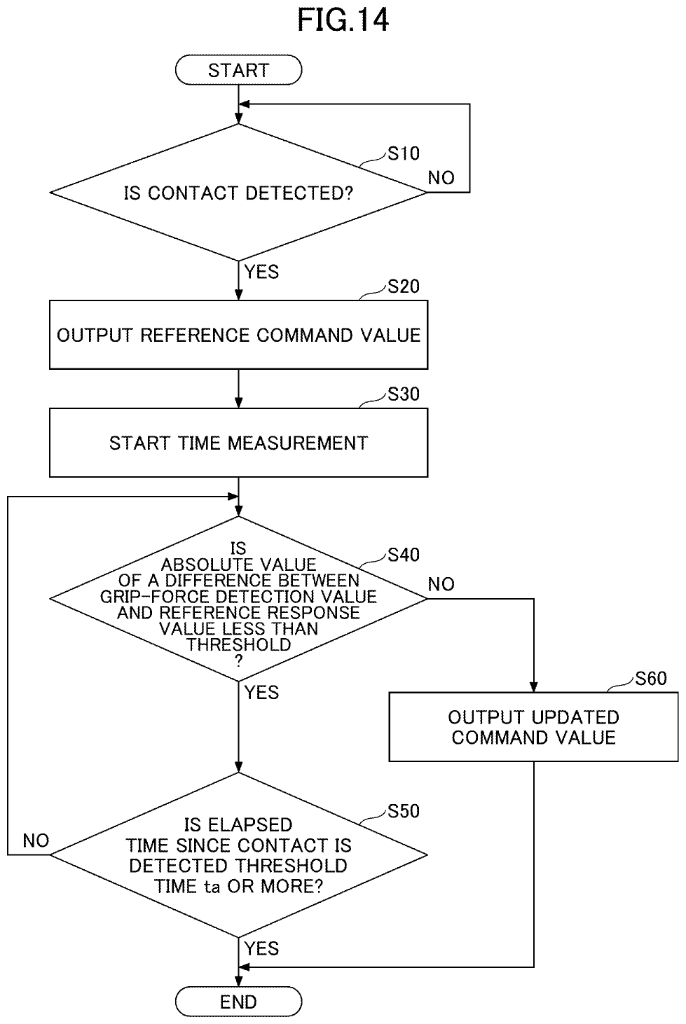

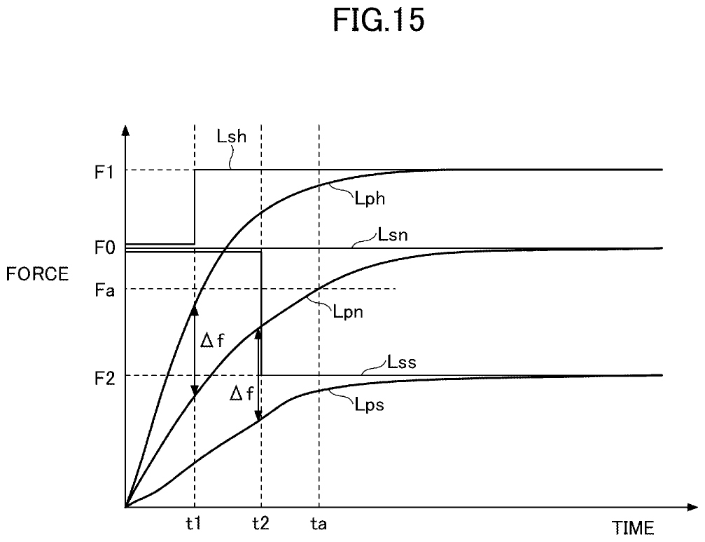

The force command generator 251b generates the force command value SVf based on the grip-force detection value PVf. FIG. 14 is a flowchart for describing a process by the force command generator 251b of the arithmetic processing unit 251 included in the controller of the gripping device according to the second embodiment. FIG. 15 is a diagram for describing the operation by the gripping device 1 according to the second embodiment.

The vertical axis in FIG. 15 expresses a force value indicative of each of the force command value SVf and the grip-force detection value PVf. The horizontal axis in FIG. 15 expresses the time from the detecting of the contact.

### Step S10

First, the force command generator 251b determines whether the contact of the first finger 21a and the second finger 21b of the grasper 20 with the grip target TGT is detected. For example, if the grip-force detection value PVf is greater than a predetermined value, the force command generator 251b determines that the first finger 21a and the second finger 21b of the grasper 20 are contacted.

If the force command generator 251b detects that the first finger 21a and the second finger 21b contact the grip target TGT (Yes in step S10), the force command generator 251b proceeds to step S20. If the force command generator 251b does not detect that the first finger 21a and the second finger 21b contact the grip target TGT (No in step S10), the force command generator 251b repeats step S10.

### Step S20

Next, the force command generator 251b outputs a reference command value F0 to the operational value calculator 51a as the force command value SVf. The operational value calculator 51a calculates the current control value MVi, while using the reference command value F0 as the force command value SVf.

### Step S30

Next, the force command generator 251b starts time measurement. It is desirable that the step S30 is performed with the step S20 simultaneously or is performed as soon as possible after the step S20 is performed.

### Step S40

Next, the force command generator 251b determines whether an absolute value of the difference between the grip-force detection value PVf and a reference response value is less than a threshold. Here, the reference response value is a given grip-force detection value PVf with respect to the time from a timing at which the grip target TGT having a reference hardness is contacted while gripping the grip target TGT. For example, as the reference response value, an actually measured value or a theoretically obtained value may be used. Any value may be set as the reference response value.

In FIG. 15, a value with respect to the time identified by the reference response value is indicated by a line Lpn. When the grip-force detection value PVf is greater than the value indicated by the line Lpn, it is estimated that the grip target TGT is harder than the reference hardness. Further, when the grip-force detection value PVf is less than the value indicated by the line Lpn, it is estimated that the grip target TGT is softer than the reference hardness.

For example, in FIG. 15, a line Lph indicates the grip-force detection value PVf that is obtained when the grip target TGT that is harder than the reference hardness is gripped. A line Lps indicates the grip-force detection value PVf that is obtained when the grip target TGT that is softer than the reference hardness is gripped.

If the absolute value of the difference between the grip-force detection values PVf and the reference response value is less than the threshold (Yes in step S40), the force command generator 251b proceeds to step S50. If the absolute value of the differences between the grip-force detection value PVf and the reference response value is greater than or equal to the threshold (No in step S40), the force command generator 251b proceeds to step S60.

### Step S50

Next, the force command generator 251b determines whether an elapsed time since the detecting of the contact is longer than or equal to threshold time ta. If the elapsed time since the detecting of the contact is longer than or equal to the threshold time ta (Yes in step S50), the force command generator 251b terminates the process. If the elapsed time since the detecting of the contact is shorter than the threshold time ta (No in step S50), the force command generator 251b returns to step S40, and then repeats the process.

### Step S60

If the absolute value of the difference between the grip-force detection value PVf and the reference response value is greater than or equal to the threshold (No in step S40), the force command generator 251b changes the force command value SVf to an updated command value, and then outputs the updated command value. For example, the force command generator 251b increases the updated command value when the grip target TGT is harder than a reference-grip target TGT. By setting the updated command value to be greater than the reference command value, the gripping device 1 can strongly grip the hard grip target TGT. Further, the force command generator 251b sets a smaller updated command value when the grip target TGT is softer than the reference-grip target TGT. By setting the updated command value to be less than the reference command value, the gripping device 1 can gently grip a soft grip target TGT.

The operation of the gripping device 1 according to the second embodiment will be described below with reference to FIG. 15. A line Lpn indicates a time response identified by the reference response value. A line Lph indicates the grip-force detection value PVf that is obtained when the grip target TGT that is harder than a reference is gripped, and a line Lps indicates the grip-force detection value PVf that is obtained when the grip target TGT having hardness that is softer than the reference is gripped. A line Lsn indicates the reference command value. A line Lsh indicates the force command value SVf that is obtained when the grip target TGT that is harder than the reference is gripped, and a line Lss indicates the force command value SVf that is obtained when the grip target TGT that is softer than the reference is gripped. The line Lsh and the line Lss are shown to be shifted up and down with respect to the reference command value F0, in order to clarify the difference from the line Lsn.

When the first finger 21a and the second finger 21b contact the grip target TGT, the grip-force detection value PVf increases over time. Here, when the grip target TGT is harder than the reference hardness, a great grip-force detection value PVf is obtained early compared to the reference response value (line Lph). When the grip target TGT is softer than the reference hardness, the grip-force detection value PVf is less than the reference response value (line Lps).

Here, it is assumed that at time t1, the absolute value of the difference between the line Lph and the line Lpn, that is, the absolute value of the difference between the grip-force detection value PVf and the reference response value become greater than or equal to a threshold Af. In this case, as indicated by a line Lsh, in step S60, the force command generator 251b changes the force command value SVf from the reference command value F0 to an updated command value F1.

Further, it is assumed that at time t2, the absolute value of the difference between the line Lps and the line Lpn, that is, the absolute value of the difference between the grip-force detection value PVf and the reference response value is greater than or equal to the threshold Δf. In this case, as indicated by a line Lss, the force command generator 251b changes the force command value SVf from the reference command value F0 to an updated command value F2 in step S60.

Further, the time ta is assumed to be a time at which the reference response value is a determination value Fa, for example, the determination value Fa (=0.8×F0) being a value that is 0.8 times the reference command value F0. If the absolute value of the difference between the grip-force detection value PVf and the reference response value is not greater than or equal to the threshold Δf within a time period, the force command generator 251b terminates the process in step S50, and then holds the force command value SVf as the reference command value F0. The threshold time ta may be determined in consideration of processing time, the response, and the like.

Note that a given value of the updated command value may be set for each of a case where a target is harder than the reference and a case where the target is softer than the reference. The given value may be changed according to a time period that is taken until the above difference exceeds the threshold.

### Action and Effect

In the gripping device according to the second embodiment, in addition to the action and effect of the gripping device according to the first embodiment, the grip force can change the grip force according to the hardness of the grip target TGT. Specifically, in the gripping device according to the second embodiment, a hard grip target TGT can be gripped strongly, and a soft grip target TGT can be gripped gently. In this arrangement, in the gripping device 1 of the second embodiment, grip targets having different hardness characteristics can be held accurately and stably. In particular, the gripping device according to the second embodiment is suitable for grasping grip targets TGT having a large difference in the hardness between the grip targets.

### Third Embodiment

The gripping device according to a third embodiment differs from the gripping device according to the second embodiment in the process by the force command generator 251b.

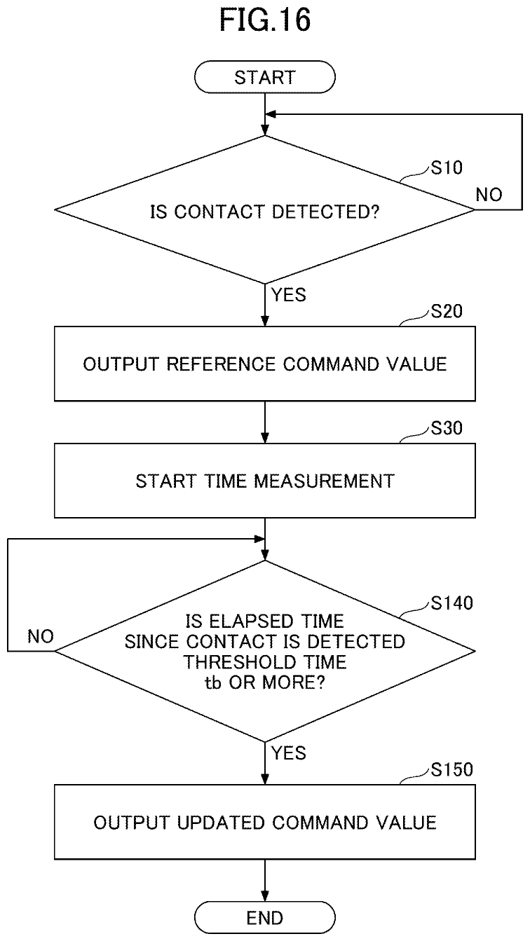

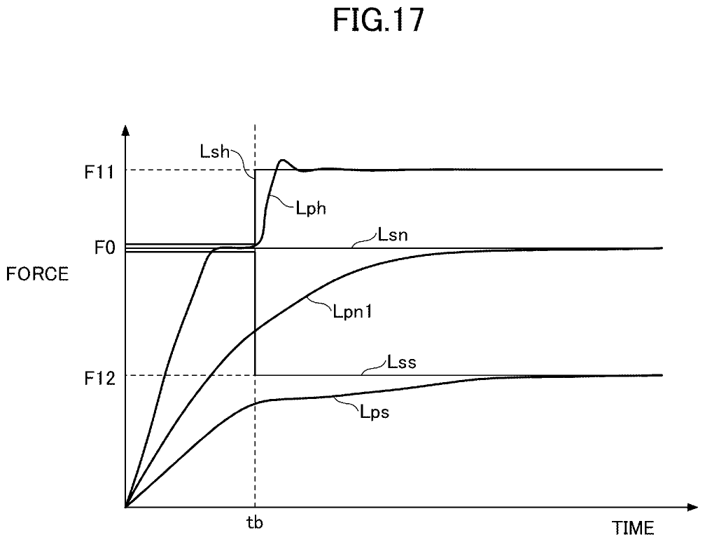

FIG. 16 is a flowchart for describing the process by the force command generator 251b of the arithmetic processing unit 251 included in the controller of the gripping device according to the third embodiment. FIG. 17 is a diagram for describing the operation of the gripping device according to the third embodiment.

The vertical axis in FIG. 17 expresses each of the force command value SVf and the grip-force detection value PVf. The horizontal axis in FIG. 17 expresses the time from the detecting of the contact.

The process in step S10, step S20, and step S30 is the same as the process by the force command generator 251b of the gripping device according to the second embodiment, and accordingly the description thereof is omitted.

### Step S140

The force command generator 251b determines whether the elapsed time since the detecting of the contact is longer than or equal to the threshold time tb. In other words, the force command generator 251b determines whether a predetermined time has elapsed. If the elapsed time since the detecting of the contact is longer than or equal to the threshold time tb (Yes in step S140), the force command generator 251b proceeds to step S150. In other words, the force command generator 251b proceeds to step S150 after the predetermined time has elapsed since the contact is detected. If the elapsed time since the detecting of the contact is shorter than the threshold time tb (No in step S140), the force command generator 251b repeats the process in step S140. The threshold time tb may be appropriately determined to be within the range that allows for the determination.

### Step S150

The force command generator 251b outputs an updated command value based on the grip-force detection value PVf that is obtained at the threshold time. For example, if a greater grip-force detection value PVf is obtained at the threshold time, it is determined that the grip target TGT is hard. Then, the power command generator 251b changes the power command value SVf to the updated command value that is greater than the reference command value. Further, if a smaller grip-force detection value PVf is obtained at the threshold time, it is determined that the grip target TGT is softer than the reference hardness. Then, the power command generator 251b changes the power command value SVf to the updated command value that is less than the reference command value. When the process in step S150 is terminated, the force command generator 251b terminates the process.

The operation of the gripping device 1 according to the third embodiment will be described below with reference to FIG. 17. A line Lpn1 indicates the grip-force detection value PVf obtained when the grip target TGT having the reference hardness is gripped. A line Lph indicates the grip-force detection value PVf obtained when the grip target TGT that is harder than the reference is gripped, and a line Lps indicates the grip-force detection value PVf obtained when the grip target TGT that is softer than the reference is gripped. A line Lsn indicates the reference command value. A line Lsh indicates the force command value SVf obtained when the grip target TGT that is harder than the reference is gripped, and a line Lss indicates the force command value SVf obtained when the grip target TGT that is softer than the reference is gripped. The line Lsh and the line Lss are shown to be shifted up and down with respect to the reference command value F0, in order to clarify the difference from the line Lsn.

When the first finger 21a and the second finger 21b contact the grip target TGT, the grip-force detection value PVf increases over time. Here, when the grip target TGT is harder than the reference hardness, a greater grip-force detection value PVf is obtained early compared to the reference response value (line Lph). When the grip target TGT is softer than the reference hardness, the grip-force detection value PVf is less than the reference response value (line Lps).

The power command generator 251b changes the power command value SVf to a given updated command value, in accordance with the gripping-power detection value PVf obtained at the threshold time tb. For example, when the grip target TGT that is harder than the reference hardness is gripped, a greater grip-force detection value PVf is obtained at the threshold time tb. In this case, the force command generator 251b changes the force command value SVf from the reference command value F0 to the updated command value F11 that is greater than the reference command value F0. For example, when the grip target TGT that is softer than the reference hardness is gripped, a smaller grip-force detection value PVf is obtained at the threshold time tb. In this case, the force command generator 251b changes the force command value SVf from the reference command value F0 to the updated command value F12 that is less than the reference command value F0.

A given value of the updated command value may be set to a first updated command value when the grip-force detection value PVf obtained at the threshold time tb is 0.8 times or more the reference command value F0, and when the grip-force detection value PVf is 0.4 times or less the reference command value F0, the given value may be set to a second updated command value. If the grip-force detection value PVf is greater than 0.4 times and less than 0.8 times the reference command value F0, the reference command value F0 may be used as the updated command value without changing the reference command value F0.

A given value of the updated command value may be determined, for example, based on the grip-force detection value PVf obtained at the threshold time tb. For example, the given value of the updated command value may be determined by Equation 2. In Equation 2, F0 expresses a given value as the reference command value, and PVf expresses a given value as the detected grip force value PVf at the threshold time tb.

$$F 0 + coefficient \times ( PVf - 0.5 \times F 0 ) \qquad ( Equation 2 )$$

### Action and Effect

The gripping device according to the third embodiment can provide the same action and effect as described in the gripping device according to the second embodiment.

### Fourth Embodiment

The gripping device according to a fourth embodiment differs from the gripping device according to the second embodiment and the third embodiment, in the process by the force command generator 251b.

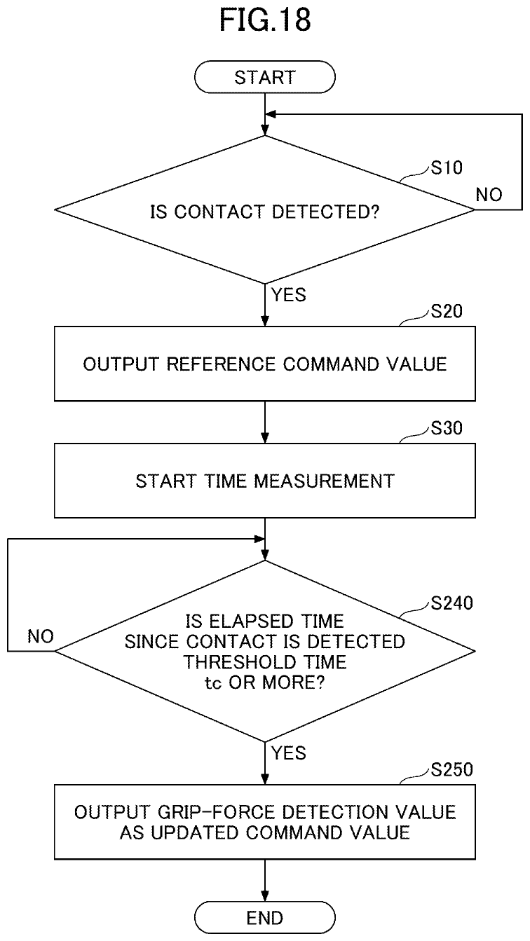

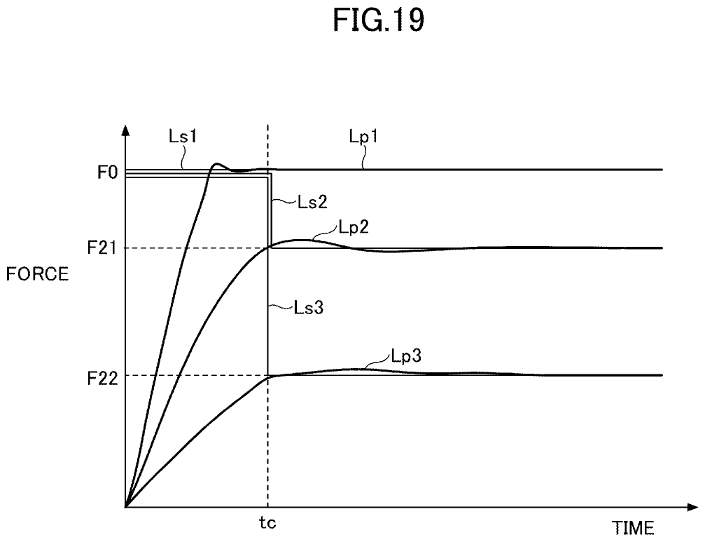

FIG. 18 is a flowchart for describing the process by the force command generator 251b of the arithmetic processing unit 251 included in the controller of the gripping device according to the fourth embodiment. FIG. 19 is a diagram illustrating the operation by the gripping device according to the fourth embodiment.

The vertical axis in FIG. 19 expresses each of the force command value SVf and the grip-force detection value PVf. The horizontal axis in FIG. 19 expresses the time from the detecting of the contact.

The process in step S10, step S20, and step S30 is the same as the process by the force command generator 251b of the gripping device according to the second embodiment, and accordingly the description thereof is omitted.

In step S20, the reference command value F20, which is the grip-force detection value PVf obtained when the grip target TGT (first grip target) assumed to be the hardest target among given grip targets is gripped, is used as the reference command value.

### Step S240

The force command generator 251b determines whether the elapsed time since the detecting of the contact is longer than or equal to a threshold time tc. In other words, the force command generator 251b determines whether a predetermined time has elapsed. If the elapsed time since the detecting of the contact is longer than or equal to the threshold time tc (Yes in step S240), the force command generator 251b proceeds to step S250. In other words, the force command generator 251b proceeds to step S250 after the predetermined time has elapsed since the contact is detected. If the elapsed time since the detecting of the contact is less than the threshold time tc (No in step S240), the force command generator 251b repeats the process in step S240. The threshold time tc may be appropriately determined within the range that allows for the determination.

### Step S250

The force command generator 251b outputs the grip-force detection value PVf obtained at the threshold time tc as an updated command value. When the process in step S250 is terminated, the force command generator 251b terminates the process.

The operation by the gripping device according to the fourth embodiment will be described below with reference to FIG. 19. A line Lp1 indicates the grip-force detection value PVf obtained when a grip target TGT (first grip target) assumed to be the hardest target among given grip targets is gripped. A line Lp2 indicates the grip-force detection value PVf obtained when a grip target TGT (second grip target) that is softer than the first grip target is gripped, and a line Lp3 indicates the grip-force detection value PVE obtained when a grip target TGT (third grip target) that is softer than the second grip target is gripped. Further, a line Ls1 indicates the power command value SVf obtained when the first grip target is gripped, a line Ls2 indicates the power command value SVf obtained when the second grip target is gripped, and a line Ls3 indicates the power command value SVf obtained when the third grip target is gripped. The line Ls2 is shown shifted with respect to the reference command value F20 and the threshold time tc to clarify the difference between lines. The line Ls3 is shown as shifted with respect to the reference command value F20 to clarify the difference between lines.

When the first finger 21a and the second finger 21b contact the grip target TGT, the grip-force detection value PVf increases over time. The force command generator 251b outputs the grip-force detection value PVf obtained at the threshold time to as the updated command value of the force command value SVf.

For example, when the first grip target is gripped, the grip-force detection value PVf is substantially the same as the reference command value F20 obtained at the threshold time tc, and thus the force command generator 251b outputs the reference command value F20 as the updated command value. When the second grip target is gripped, the force command generator 251b outputs the updated command value F21 that is the grip-force detection value PVf obtained at the threshold time tc. When the third grip target is gripped, the force command generator 251b outputs the updated command value F22 that is the grip-force detection value PVf obtained at the threshold time tc.

### Action and Effect

The gripping device according to the fourth embodiment can provide the same action and effect as described in the gripping device according to the second embodiment. In particular, in the fourth embodiment, the process by in the force command generator 251b is simplified.

Although the gripping device is described above according to the embodiments, the present invention is not limited to the above-described embodiments. Various modifications and improvements such as combinations with or substitutions of a portion or all of the other embodiments can be made within the scope of the present invention.

This application claims priority of Japanese Patent Application No. 2021-135160, filed on Aug. 20, 2021, the entire contents of which are incorporated herein by reference.

### DESCRIPTION OF THE REFERENCE NUMERAL

1 gripping device
10 drive unit
11 power unit
11e encoder
11m motor
12 motion converter
20 grasper
21a first finger
21b second finger
30 force detector
31a first force sensor
31b second force sensor
40 motor drive unit
50 controller
51 arithmetic processing unit
5la operational value calculator
51a1 admittance processing unit
51a2 integration operator
51a3 position-and-speed calculator
51a4 current calculator
51a5 position-command value generator
51a6 contact determination unit
51a7 switching unit
51a8 value holder
51b force command generator
52 motor controller
53 motor-operation data acquiring unit
54 force-measurement data acquiring unit
151a operational value calculator
251 arithmetic processing unit
251b force command generator
252a7 switching unit

1. A gripping device comprising:
a motor and a detector configured to detect a position and a speed of a rotary shaft of the motor;
a motor drive circuit configured to
supply power by which the motor is driven based on a current control value, and
detect a magnitude of a current that is provided to the motor;
a grasper including a first finger and a second finger, the grasper being configured to grip an object with the first finger and the second finger, by changing a distance between the first finger and the second finger in accordance with rotation of the motor;
a force detector configured to detect a grip force that enables the object to be gripped by the first finger and the second finger, upon occurrence of a condition in which the object is gripped by the first finger and the second finger; and
processing circuitry configured to
control the current control value such that a value of the grip force detected by the force detector matches a force command value, and
output the controlled current control value to the motor drive circuit,
wherein the processing circuitry is configured to
convert the force command value to a first position command value,
generate a second position command value,
detect that the first finger or the second finger contacts the object,
change, upon detecting that the first finger or the second finger contacts the object, the second position command value to the first position command value,
convert one of the first position command value and the second position command value, to a current command value,
control the current control value such that the magnitude of the current matches the current command value, and
set the first position command value as a value of the position of the rotary shaft detected by the detector, in a case where the second position command value is changed to the first position command value.

2. The gripping device according to claim 1, wherein the processing circuitry is configured to generate the second position command value that varies at a constant rate until the second position command becomes a constant value.

3. The gripping device according to claim 1, wherein the processing circuitry is configured to generate the current command value such that the value of the position of the rotary shaft detected by the detector matches one of the first position command value and the second position command value.

4. The gripping device according to claim 1, wherein the processing circuitry is configured to generate the first position command value such that the value of the detected grip force matches the force command value.

5. A control method by a gripping device that includes
a motor and a detector configured to detect a position and a speed of a rotary shaft of the motor;
a motor drive circuit configured to supply power by which the motor is driven based on a current control value, and detect a magnitude of a current that is provided to the motor;
a grasper including a first finger and a second finger, the grasper being configured to grip an object with the first finger and the second finger, by changing a distance between the first finger and the second finger in accordance with rotation of the motor; and
a force detector configured to detect a grip force that enables the object to be gripped by the first finger and the second finger, upon occurrence of a condition in which the object is gripped by the first finger and the second finger, the gripping device controlling the current control value for the motor drive circuit such that a value of the grip force detected by the force detector matches a force command value, the control method comprising:
converting the force command value to a first position command value;
generating a second position command value;
detecting that the first finger or the second finger contacts the object;
converting either the first position command value or the second position command value to a current command value, wherein the second position command value is converted to the current command value before detecting that the first finger portion or the second finger portion contacts the object, and the first position command value is converted to the current command value after detecting that the first finger portion or the second finger portion contacts the object;
controlling the current control value such that the magnitude of the current matches the current command value and outputting the controlled current control value; and
setting the first position command value as a value of the position of the rotary shaft detected by the detector, upon detecting that the first finger or the second finger contacts the object.
